(19) United States
(12) Patent Application Publication
(10) Pub. No.: US 2026/0260480 A1
(43) Pub. Date: Sep. 3, 2026

(54) CHARACTER RECOGNITION TECHNIQUES FOR DATA ANALYSIS IN LARGE SETS OF DOCUMENTS

(71) Applicant: Actfore, Reston, VA (US)

(72) Inventors: Syeda Yumna Batool Zaidi, Reston, VA (US); Sanskriti Shivhare, Washington, DC (US)

(73) Assignee: Actfore, Reston, VA (US)

(21) Appl. No.: 19/066,964

(22) Filed: Feb. 28, 2025

(51) Int. Cl. G06V 10/94; G06T 5/73; G06T 5/94; G06V 10/26; G06V 10/30; G06V 30/148; G06V 30/19

(52) U.S. Cl. CPC G06V 10/955; G06T 5/73; G06T 5/94; G06V 10/26; G06V 10/30; G06V 10/95; G06V 30/148; G06V 30/19; G06T 2207/30176

(57) ABSTRACT

A computer-implemented method performed by two or more processors via parallel processing for improving character recognition is disclosed. The computer-implemented method includes receiving a plurality of documents stored in one or more databases; generating, via the parallel processing by the two or more processors, a corresponding image for each page of the plurality of documents; processing the corresponding image of each page of the plurality of documents to enhance character recognition in each corresponding image; performing the character recognition in the corresponding image of each page of the plurality of documents to yield a plurality of recognized characters in the plurality of documents; and reconstructing each page of the plurality of documents to include corresponding one or more characters from the plurality of recognized characters.

### CROSS-REFERENCE TO RELATED APPLICATIONS

This application is also related to U.S. Non-Provisional patent application Ser. No. 19/050,830, Attorney Docket No. 129807-826593, filed on Feb. 11, 2025, entitled “Template Identification and Matching for Data Analysis in Large Sets of Documents”; and U.S. Non-Provisional patent application Ser. No. 19/066,809, Attorney Docket No. 129807-826647, filed on Feb. 28, 2025, entitled “Techniques for Targeted Data Extraction from Unstructured Sets of Documents”; the contents of which are hereby expressly incorporated by reference in their entirety.

### FIELD OF DISCLOSURE

The present technology relates to the field of data mining and document review, and in particular techniques for improving character recognition for data analysis in large sets of documents.

### BACKGROUND

In today's digital age, with an ever-growing reliance on online communications, cybersecurity has become a critical priority for organizational management teams. Robust safeguards are essential to prevent or effectively mitigate cybersecurity breaches. However, in the event of such breaches (cyber incidents), organizations often rely on manual data review processes to identify compromised information and fulfill notification requirements.

This manual approach is fraught with inefficiencies-it is slow, error-prone, and ill-suited to address the increasing complexity and volume of modern data ecosystems. Teams are required to sift through diverse data types, languages, and formats, making this an arduous task that frequently results in delays and inaccuracies. Furthermore, the unstructured nature of the data poses significant challenges to efficient document processing and data analysis, highlighting the urgent need for innovative solutions to address these inefficiencies.

### SUMMARY

In one aspect, one or more non-transitory computer-readable media including computer-readable instructions is disclosed. The computer-readable instructions when executed by two or more processors of a system for improving character recognition, cause the system to: (i) receive, via parallel processing, a plurality of documents stored in one or more databases; (ii) generate, via the parallel processing, a corresponding image for each page of the plurality of documents(iii) process, via the parallel processing, the corresponding image of each page of the plurality of documents to enhance character recognition in each corresponding image; (iv) perform, via the parallel processing, the character recognition in the corresponding image of each page of the plurality of documents to yield a plurality of recognized characters in the plurality of documents; and (v) reconstruct, via the parallel processing, each page of the plurality of documents to include corresponding one or more characters from the plurality of recognized characters.

In another aspect, processing the corresponding image includes converting the corresponding image into a corresponding grayscale image; applying Gaussian blurring to the corresponding grayscale image to reduce noise present in the corresponding grayscale image; subsequent to applying the Gaussian blurring, enhancing text clarity in the corresponding grayscale image by sharpening the corresponding grayscale image; and enhancing contrast for the character recognition in the corresponding grayscale image by dividing the corresponding grayscale image based on blurred areas of the corresponding grayscale image.

In another aspect, the character recognition is performed using an optical character recognition (OCR) engine.

In another aspect, reconstructing each page includes converting, via the parallel processing by the two or more processors, the corresponding one or more characters into a machine-readable format; and embedding, via the parallel processing by the two or more processors, the machine-readable format into a corresponding page of the plurality of documents.

In another aspect, the computer-implemented method further includes storing, via the parallel processing by the two or more processors, the plurality of documents with the corresponding one or more characters at a user-specified directory path; and generating, via the parallel processing by the two or more processors, a summary detailing one or more of: a total number of documents that were processed, a total number of successful conversions, and a total number of errors.

In another aspect, the character recognition is performed using a trained language model.

In another aspect, the plurality of documents includes characters associated with at least two different languages, and the character recognition for each of characters associated with the at least two different languages is performed using a respective trained language model.

In one aspect, a system for improving character recognition is disclosed. The system includes at least one memory configured to store computer-readable instructions; and two or more processors communicatively coupled with the at least one memory, and configured to execute the computer-readable instructions to: (i) receive, via parallel processing, a plurality of documents stored in one or more databases; (ii) generate, via the parallel processing, a corresponding image for each page of the plurality of documents (iii) process, via the parallel processing, the corresponding image of each page of the plurality of documents to enhance character recognition in each corresponding image; (iv) perform, via the parallel processing, the character recognition in the corresponding image of each page of the plurality of documents to yield a plurality of recognized characters in the plurality of documents; and (v) reconstruct, via the parallel processing, each page of the plurality of documents to include corresponding one or more characters from the plurality of recognized characters.

In one aspect, at least one non-transitory computer-readable media (CRM) storing computer-readable instructions stored thereon is disclosed. The computer-readable instructions when executed by two or more processors of a system for improving character recognition, cause the system to: (i) receive, via parallel processing, a plurality of documents stored in one or more databases; (ii) generate, via the parallel processing, a corresponding image for each page of the plurality of documents (iii) process, via the parallel processing, the corresponding image of each page of the plurality of documents to enhance character recognition in each corresponding image; (iv) perform, via the parallel processing, the character recognition in the corresponding image of each page of the plurality of documents to yield a plurality of recognized characters in the plurality of documents; and (v) reconstruct, via the parallel processing, each page of the plurality of documents to include corresponding one or more characters from the plurality of recognized characters.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram of an example network diagram according to some aspects of the present disclosure.

FIG. 2 illustrates an example view of a graphical user interface of a frontend application executing on a client device according to some aspects of the present disclosure.

FIG. 3 illustrates an example of a computing system in accordance with certain embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable unless the term “configurable” is explicitly used to distinguish from “configured.” The proper understanding of the term will be apparent to persons of ordinary skill in the art in the context in which the term is used.

Claim language or other language reciting “at least one of a set and/or ”one or more“ of a set indicates that one member of the set or multiple members of the set (in any combination) satisfy the claim. For example, claim language reciting ”at least one of A and B“ or ”at least one of A or B“ means A, B, or A and B. In another example, claim language reciting ”at least one of A, B, and C“ or ”at least one of A, B, or C“ means A, B, C, or A and B, or A and C, or B and C, or A and B and C. The language ”at least one of a set and/or “one or more” of a set does not limit the set to the items listed in the set. For example, claim language reciting “at least one of A and B” or “at least one of A or B” can mean A, B, or A and B, and can additionally include items not listed in the set of A and B.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

As used herein, the term “configured” shall be considered to be used interchangeably with configured and configurable, unless the term “configurable” is explicitly used to distinguish from “configured.” The proper understanding of the term will be apparent to persons of ordinary skill in the art in the context in which the term is used.

Various technical features may be readily apparent to one skilled in the art from the following figures, descriptions, and claims.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

Aspects of the present disclosure can be implemented in any device, system or network that is capable of communicating with one or more client devices and one or more databases over a network. Alternatively, various aspects of the present disclosure can be implemented at a client device that is configured to store a plurality of documents at a local memory or access the plurality of documents stored at the one or more databases. The one or more databases are stored at one or more database servers.

As noted above, cybersecurity is an ever-present concern for any individual and/or organization with online presence. Robust safeguards are essential to prevent or effectively mitigate cybersecurity breaches. However, in the event of such breaches (cyber incidents), organizations often rely on manual data review processes to identify compromised information and fulfill notification requirements. This manual approach is fraught with inefficiencies-it is slow, error-prone, and ill-suited to address the increasing complexity and volume of modern data ecosystems.

Accordingly, aspects of the present disclosure are directed to addressing challenges associated with data/document review processes. In the present case, the data review processes are described in accordance with identifying, extracting, and compiling compromised information, meeting notification requirements, and/or any other known or desired data processing task. However, the data review processes, as described herein, may be used for other use cases as well, and solves issues riddled with inefficiencies, slow and error-prone processing due to growing complexity and volume of today's data structures.

A pipeline (which can be automated), according to various aspects of the present disclosure, streamlines handling of data stored in a plurality of documents. By way of an example, the plurality of documents includes data stored in portable document format (PDF) files. However, data stored in another format files, for example, word, etc., fall within the scope of the present disclosure. The plurality of documents in multiple different formats may be converted to scanned documents. The scanned documents may be in any of the PDF, tagged image file format (TIFF), or other known or to be developed image formats, which are machine-readable file formats using optical character recognition (OCR) techniques. Additionally, or alternatively, various image processing techniques, OCR tools, and parallel computing strategies may be used for efficiently processing large batches of documents. As a result, a collection of searchable, text-embedded PDFs, along with detailed error and success logs may be generated for further review.

The automated pipeline includes a frontend application, which may also be referenced herein as a box selector application. The box selector application enables a user of the frontend application to view a plurality of documents and select a document of the displayed plurality of documents. The user can view the selected document on the graphical user interface and initiate a process of improving character recognition for data analysis in large sets of documents. The frontend application may further be configured to receive identification of one or more directory paths where the plurality of documents on which the improved character recognition process is to be performed, is/are stored, and one or more output directory paths where the plurality of documents, after completion of the improved character recognition process, may be saved or stored (for further retrieval and access). Additionally, or alternatively, the frontend application may further be configured to enable specification of a number of processes or threads that can be initiated for parallel processing of the plurality of documents, as described herein. For example, an input may be received indication a number of desired parallel processes to be initiated, which results in efficient handling of multiple documents simultaneously. Once input(s) specifying a number of parallel processes is detected, the frontend application can distribute the plurality of documents to the specified number of processes for performance of the OCR, results of each parallel process being stored in a corresponding output folder as described above. The frontend application may further be configured to queue specified files for processing (e.g., as part of the parallel processing) until all files are processed.

The process of improving character recognition for data analysis in large sets of documents includes preprocessing the documents in an image format to enhance OCR accuracy. In particular, OCR techniques are applied using parallel processing techniques to concurrently handle or process multiple documents to extract text from the multiple documents. In one examples, each document of the multiple documents may be in an image format, a PDF format, or any other known or to be developed format on which OCR techniques may be applied for character recognition. Additionally, detailed reports, for example, log files, may be generated to track progress and/or errors occurred during the parallel processing of the multiple documents. As a result, a large volume of documents is processed in an automated manner, converting the content of the documents into structured data with minimal manual intervention.

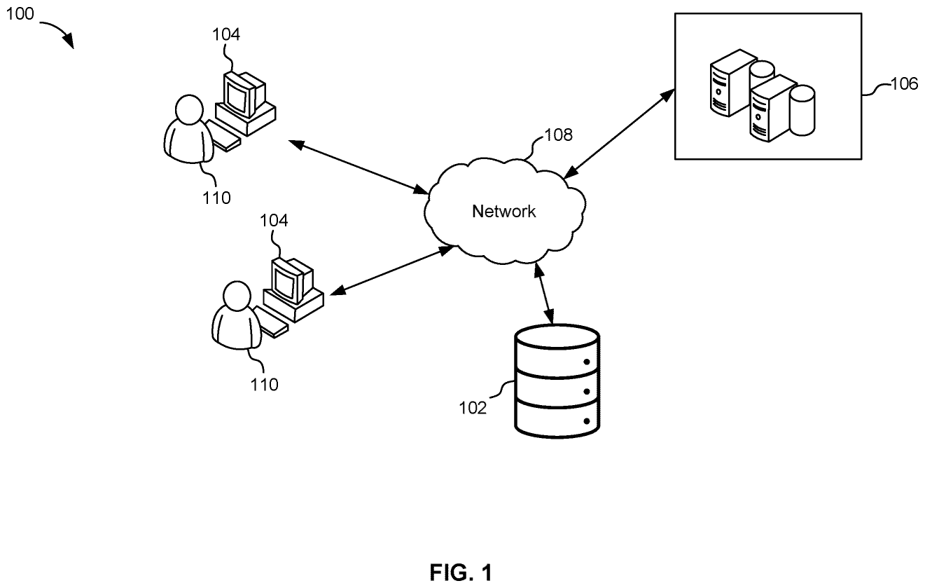

FIG. 1 illustrates a block diagram of an example network diagram according to some aspects of the present disclosure. As depicted in FIG. 1, the example environment 100 includes client devices 104, a server 106 and a database 102 (which may be a remote database and communicatively coupled with the server 106) that are communicatively coupled with each other via a network 108. Alternatively, the database 102 may be a local database to the server 106. In some examples, the network 108 may include, but is not limited to, a Local Area Network (LAN), a Wide Area Network (WAN), the Internet, or a combination thereof. In some examples, the network 108 may be accessed over a wired and/or a wireless communication link.

The database 102 may be in a cloud node maintained by a Cloud Service Provider (CSP) or a cloud vendor. The database 102 may store a plurality of documents that can be accessed by the server 106 and/or the client devices 104 for performing one or more operations, as described herein. In some examples, the operations may include data storage operations, data processing operations, and/or the like. The plurality of documents stored in the database 102 may be in PDF format, word format, or any other known or to be developed format.

In some examples, the computing resources at the server 106 may include network resources, data storage, servers, applications, and services. Example of the network resources may include routers, network bandwidth, network management software, and/or the like. Examples of the data storage may include storage resources, memory, Random Access Memory (RAM), databases, and/or the like. Examples of the servers may include processors, hardware servers, Virtual Machines (VMs), hypervisor, containers, and/or the like. Examples of the applications and services may include email applications, data collection/processing applications, accounting applications, Human Resource (HR) related applications, medical related applications, and/or the like. In some examples, the resources at the server 106 may include cloud resources, cloud computing resources, or the like.

The client devices 104 may be associated with the entity (also referenced herein as a user or operator, or the like) and used by users 110 of the client devices 104 (users may also be referred to as operators). In some examples, each of the users may include an organization, a corporation, a business unit of a corporation, a department of a corporation, a banking unit, a medical/healthcare unit, and/or the like. In some examples, each of the users 110 may include an administrator, a subject matter expert (SME), an investigator, and/or the like. Examples of the client devices 104 may include a desktop, smartphones, laptops, a tablet, voice-enabled devices, and/or the like. It is contemplated that the implementations of the present disclosure may be realized with any appropriate type of computing device.

The client devices 104 may be utilized by a respective user of the users 110 to log into and interact with the server 106 for handling of data stored in the plurality of documents, which are stored in the database 102. The server 106 implements the automated pipeline that is configured to identify and categorize unique templates in each of the plurality of documents. Each document of the plurality of documents may be a PDF file. The server 106 is configured to perform pairwise comparison to group similar files into a plurality of clusters. As described herein, the same PDF file can be part of more than one cluster, and each cluster is configured to process the files included in that cluster as a batch process, for example, for data analysis, data mining, and/or data processing.

In some examples, the client devices 104 may display one or more Graphical User Interfaces (GUIs) that enable the respective user to interact with the server 106 and/or the database 102 for batch processing of the plurality of documents stored at the database 102. Interacting with the server 106 may include initiating a request to display a plurality of documents in a GUI and selecting two or more documents of the plurality of documents for batch processing. Alternatively, the server 106 may periodically perform batch processing of the plurality of documents.

In some examples, the server 106 may be implemented as an on-premises system. In some other examples, the server 106 may be implemented as an off-premises system (for example, a cloud or an on-demand system). Additionally, or alternatively, the server 106 may be implemented in a cloud environment. For simplicity, the server 106 depicted in FIG. 1 may be a cloud environment that is intended to represent various forms of servers including a web server, an application server, a proxy server, a network server, a server pool, and/or the like.

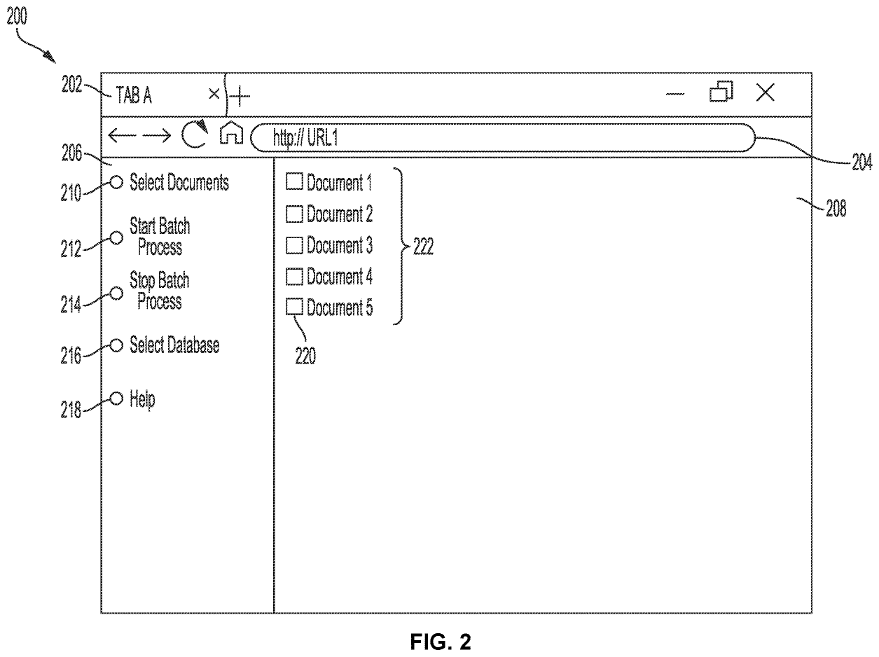

FIG. 2 illustrates an example view 200 of a graphical user interface (GUI) of a frontend application executing on a client device 104 according to some aspects of the present disclosure. The frontend application may be a web browser application, a mobile application, or a native application executing on the client device 104. The frontend application executing on the client device 104 may be communicatively coupled with a backend application executing on the server 106. The backend application executing on the server 106 is communicatively coupled with the database 102. Additionally, or alternatively, the frontend application executing on the client device 104 may also be communicatively coupled with the database 102.

As shown in the view 200 of the GUI, the frontend application may connect with the backend application by accessing a uniform resource locator (URL) address in an address bar 204 of a tab 202. Upon establishing a connection between the frontend application and the backend application using HyperText Transfer Protocol (http) or HyperText Transfer Protocol Secure (https), the backend application executing on the server 106 may render a page for displaying on the GUI as shown in FIG. 2. The page rendered for display on the frontend application may include a menu selection pane 206 and a data display and selection pane 208 (a selection pane may also be referred to as a selection window, a selection frame, a selection section, etc.).

The menu selection pane 206 may display a plurality of menu options including, but not limited to, a select documents option 210, a start batch process option 212, a stop batch process option 214, a select database option and improve character recognition 216, and a help option 218. The help option 218 may provide the user various information such as documentation about using the user interface shown in FIG. 2 for selecting various documents for various operations. Various operations that may be performed on one or more documents may include, but not limited to, text extraction, text editing, text structuring, data mining, etc. Various operations on the one or more documents may be performed as batch processing operations.

The database stores a plurality of documents, and upon selecting the database, a plurality of documents stored in the database are displayed in the data display and selection pane 208 by selecting the select documents option 210. Upon selection of the select documents option 210, document 1, document 2, document 3, document 4, and document 5 are displayed in the data display and selection pane 208 as 222. One or more documents displayed in the data display and selection pane 208 may be selected using their respective checkbox that is shown in FIG. 2 as checkbox 220. The one or more documents such selected using a respective checkbox may be batch processed upon selecting the start batch process option 212. The stop batch process option 214, once selected, stops (or terminates) the batch process, which may be for any reason. Assuming that the user has selected one or more checkboxes corresponding to one or more of the displayed documents, the user may select the improve character recognition option 217 for improving character recognition for data analysis in the one or more selected documents.

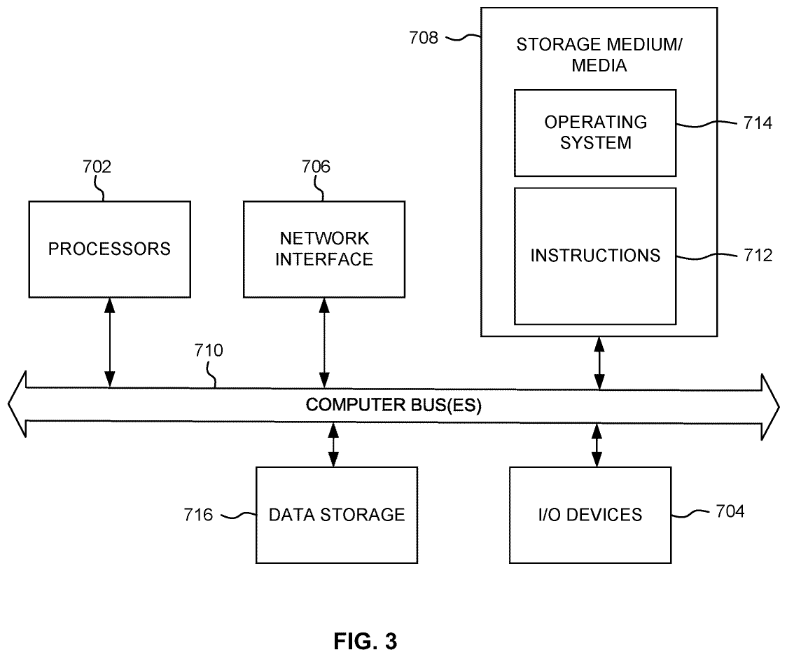

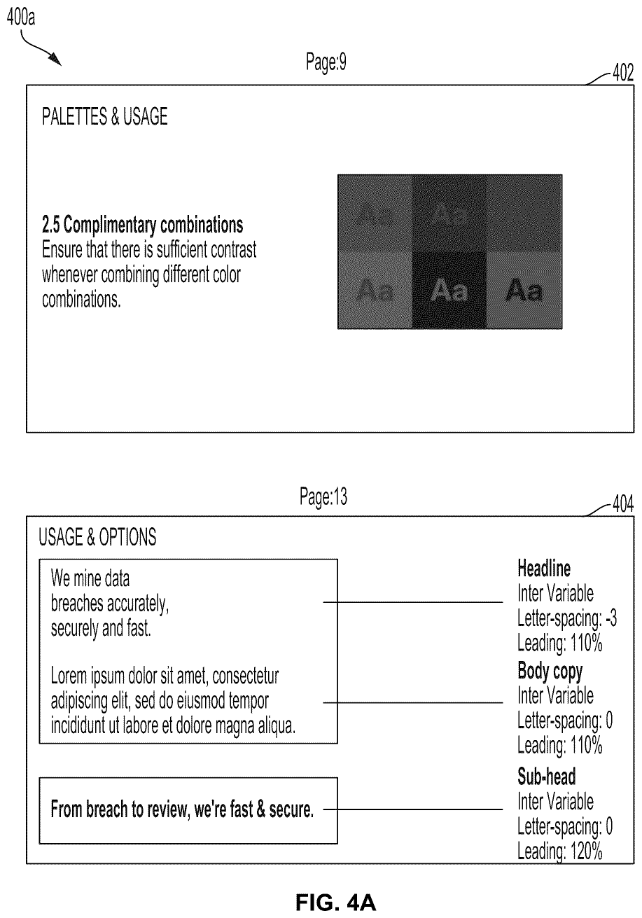

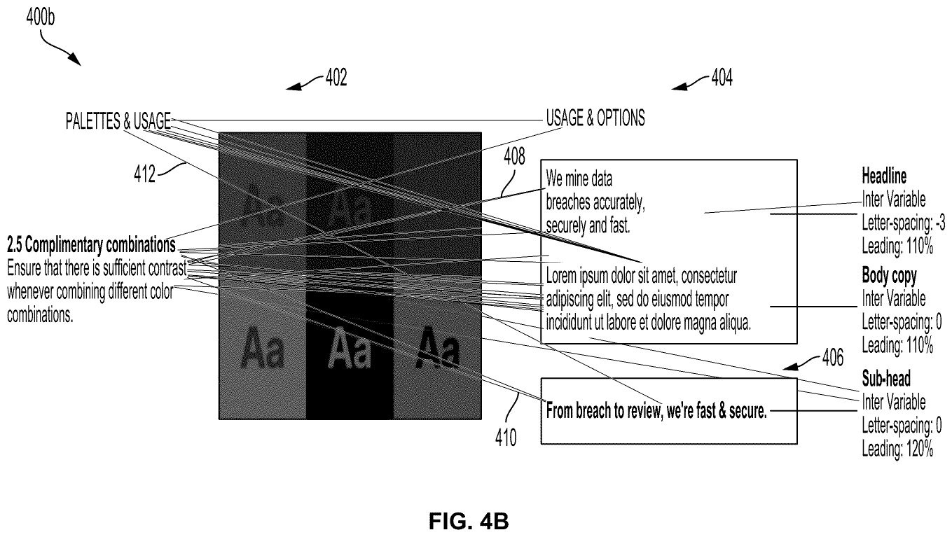

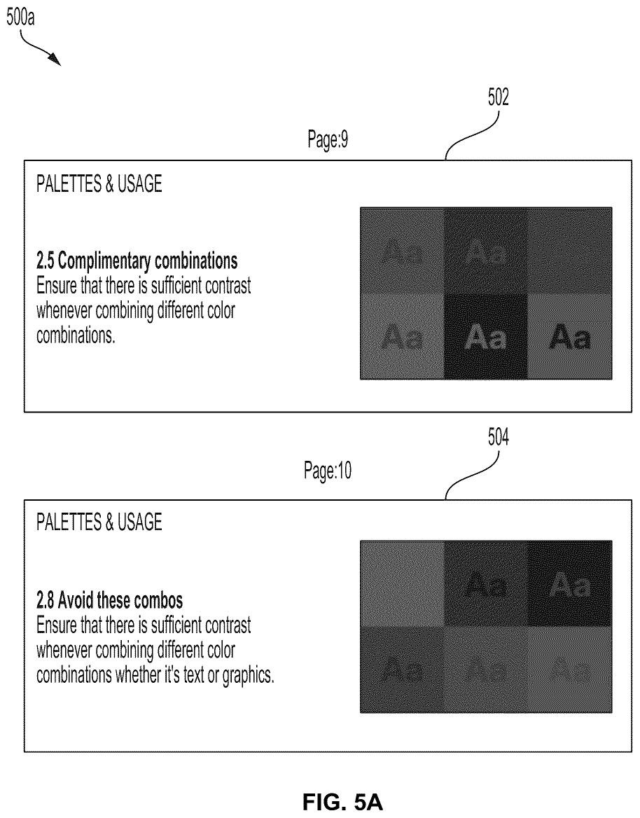

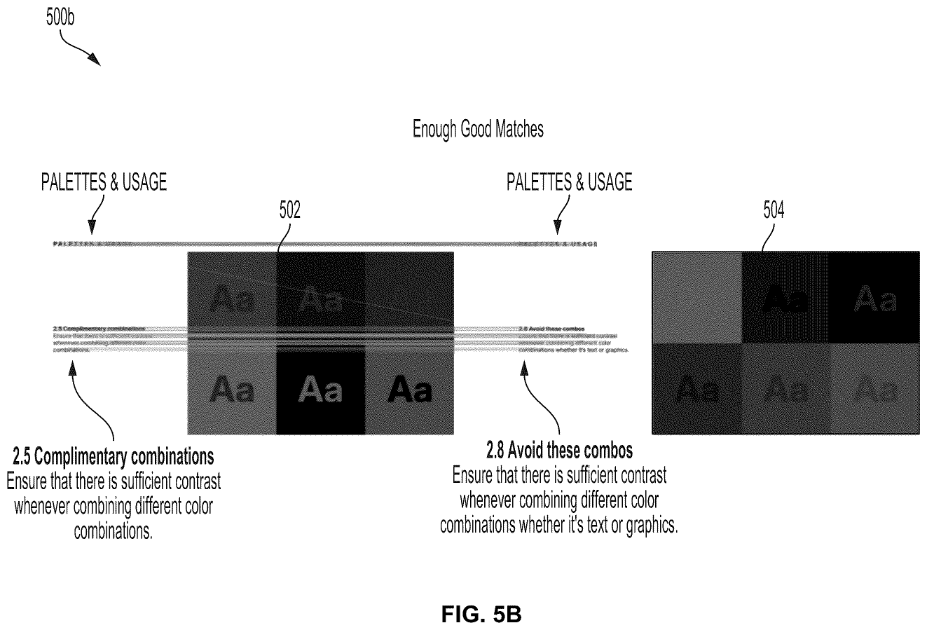

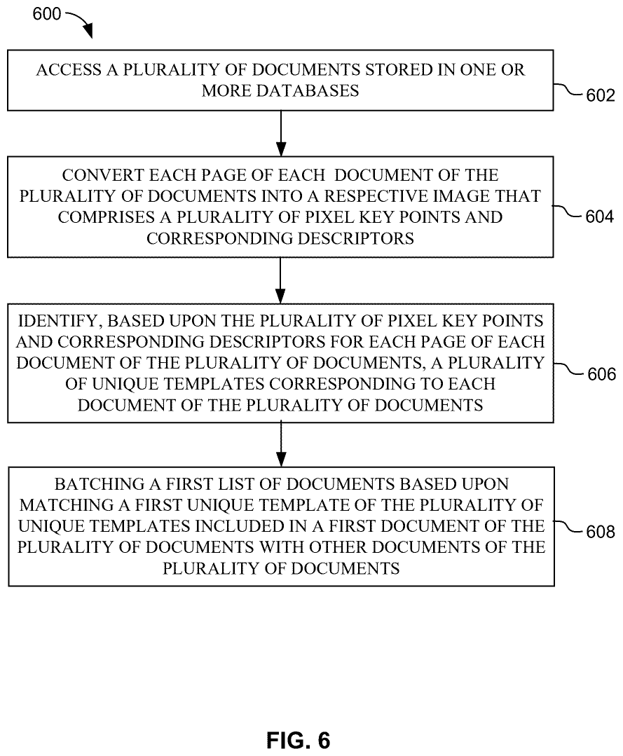

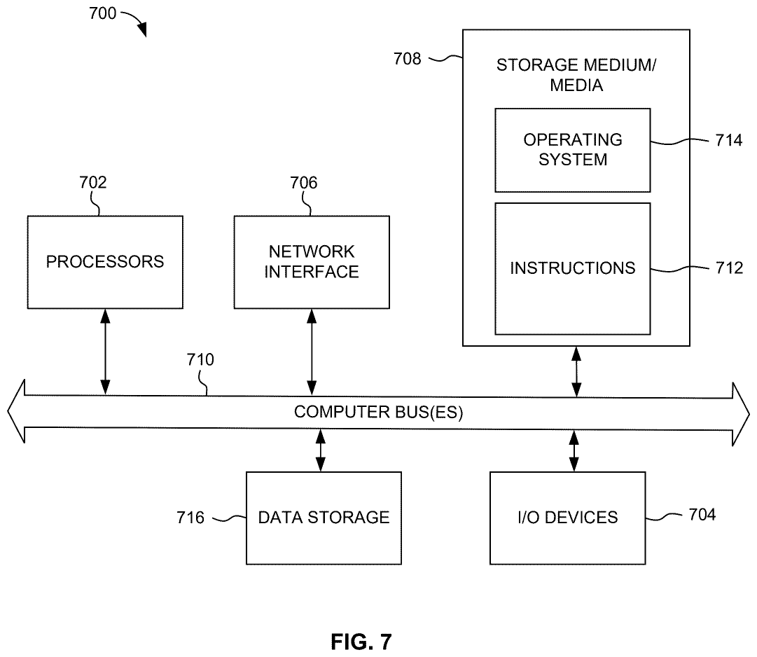

The following description illustrates an example flow of method operations of improving character recognition for data analysis in large sets of documents according to some aspects of the present disclosure. The method operations may be performed by the client device 104 or the server 106. Further, the method operations may be performed via parallel processing by two or more processors (shown in FIG. 3 as processor 702) at the same time, for example, using Python's multiprocessing library. Python's multiprocessing library divides workload (or processing tasks or operations) across multiple CPU cores, and thereby significantly improves operational speed of the processing tasks or operations. These method operations may be initiated and monitored through the graphical interfaces shown and described with reference to FIGS. 1 and 2.

In operation, the server 106 may receive a plurality of documents stored in one or more databases. The plurality of documents stored in the one or more databases may be retrieved upon selection by the user as described herein with reference to FIG. 2. The plurality of documents may be in any format, such as a word format, a PDF format, etc. Upon selection of one or more documents of the plurality of documents, each of the selected documents is accessed using a directory path associated with the selected document. The directory path associated with each document of the plurality of documents may be stored, for example, in an Excel file.

Upon selection of one or more documents of the plurality of documents by the user, the server 106 may generate a corresponding image for each page of the selected document of the plurality of documents. Each page of the one or more documents may be converted into a respective image using OCR techniques. Generated images corresponding to each page of the one or more documents may be stored in one or more databases. Each of the one or more databases may either be a local database or a remote database for the client device 104 or the server 106 performing the method operations.

The server 106 may then process the corresponding image of each page of the plurality of documents to enhance character recognition in each corresponding image. The following paragraphs describe one non-limiting example of this image enhancement process.

First, the server 106 may convert each image into a grayscale image. This conversion can be performed according to any known or to-be-developed method of converting an image into a grayscale image. The image converted into grayscale helps reduce noise and makes the image document more suitable for OCR.

Next, the server 106 may apply Gaussian blurring to the corresponding grayscale image to reduce noise present in the corresponding grayscale image. By applying the Gaussian blurring, details in the grayscale image that can likely interfere with text recognition using OCR techniques may be smoothed. Gaussian blur is a type of low-pass filter that smooths uneven pixel values in an image by cutting out the extreme outliers. Gaussian blurring is applied, for example, to soften the image so that any text over an image stands out more clearly.

The server 106, subsequent to applying the Gaussian blurring, may enhance the text clarity in the corresponding grayscale image by sharpening the corresponding grayscale image. By way of example, text clarity in the grayscale image, after applying the Gaussian blurring, may be enhanced by adjusting settings such as sharpness, contrast, and/or brightness using clarity tools.

The server 106 may then enhance contrast for the character recognition in the corresponding grayscale image. Contrast may be enhanced by dividing the corresponding grayscale image based on blurred areas of the corresponding grayscale image. Since many clarity tools are available and known to a person skilled in the art, details of the clarity tools are not provided herein for the sake of brevity. By sharpening the grayscale image and enhancing contrast in the grayscale image, text in the grayscale image is made more distinct, and thereby improving character recognition using OCR techniques.

With the process of enhancing character recognition completed as described above, the method proceeds to perform character recognition for each enhanced image.

The server 106 may perform the character recognition in the corresponding image of each page of the plurality of documents to yield a plurality of recognized characters in the plurality of documents. Alternatively, character recognition may be performed for a selected area or box of an image enhanced for character recognition. By way of an example, only the selected area or box of the image may be enhanced for character recognition. The process of boxing and selecting an area may be performed according to examples described in U.S. application Ser. No. 19/066,809 filed on Feb. 28, 2025, the entire content of which is incorporated herein by reference.

The character recognition may be performed using an OCR engine. Additionally, or alternatively, the character recognition may be performed using a trained language model. The trained language model may be used for determining a language associated with character recognition. Accordingly, more than one trained language model may be used where each trained language model is associated to identify and detect text in a particular language.

The server 106 may reconstruct each page of the plurality of documents to include corresponding one or more characters from the plurality of recognized characters based upon the performed character recognition. The following paragraphs describe one example of such reconstruction.

The server 106 may convert the corresponding one or more characters into a machine-readable format using the known or to be developed OCR techniques.

The server 106 may embed the machine-readable format of each character into a corresponding page of the plurality of documents. As a result of reconstruction, each document of the plurality of documents includes the original image with the extracted text as embedded text, which makes the document searchable and machine-readable.

The server 106 may store the plurality of documents with the corresponding one or more characters at a user-specified directory path (e.g., in the database 102). In other words, the recognized text is embedded into a document, for example, a PDF document. If the document is a multi-page document, then each page is processed independently, as described herein, and the text identified using the embodiments described herein is inserted into its respective reconstructed page of the document. In one example, the reconstructed pages may be consolidated into a single PDF document, which may then be written into an output directory as described above. In another example, each reconstructed page may be stored in a corresponding directory as defined via one or more inputs on the frontend application, based on being assigned to a different one of the parallel processes, etc.

The server 106 may generate a summary. The summary may include a total number of documents that were processed, a total number of successful conversions, and/or a total number of errors. In some aspects, any issues that occurred while performing the method operations may be logged in one or more log files. Issues related to an error such as, but not limited to, OCR failures, an unreadable file, one or more missing pages, and/or a corrupted file, etc., while performing operations described herein may be logged in one or more error log files. Similarly, details about successful conversions including, but not limited to, input and/or output file paths, etc., may be logged in one or more success log files. As a result, the user may be informed about effectiveness of the process and any possible problem areas. By way of an example, the one or more error log files, or the one or more success log files may be password-protected files, and may be accessed by providing proper credentials (e.g., user identification and password).

The OCR techniques described in the present disclosure may be implemented, for example, using Tesseract, which is an OCR engine. After completion of the operations, as described herein, the results may be displayed on the GUI or a file path of the generated log files may be displayed on the GUI. The user may also be notified by displaying a message on the GUI or sending a notification message to the user via an email, a text, or a short messaging service (SMS).

Various aspects of the disclosure thus provide benefits of scalability, accuracy, error handling, comprehensive logging, and user-friendly output. By combining advanced image preprocessing techniques, OCR, and parallel processing, an automated, efficient, and scalable solution for converting scanned documents into machine-readable formats for large batches of documents is made possible. The error-handling mechanisms and detailed logging ensure that the user is always informed of the status of the processing, and the output documents (for example, PDF files) are searchable and editable.

Steps described above with reference to FIGS. 1 and 2 may each be performed as part of an overall parallel processing using two or more processors. This parallel processing is a highly scalable solution that can significantly enhance the accuracy, the speed, and the efficiency of processing large sets of documents.

Improved character recognition through techniques described herein may utilized as part of a batch processing of large sets of documents. Non-limiting examples of batch processing are described in U.S. Non-Provisional patent application Ser. No. 19/050,830, Attorney Docket No. 129807-8265 93, filed on Feb. 11, 2025, entitled “Template Identification and Matching for Data Analysis in Large Sets of Documents”; and U.S. Non-Provisional patent application No. ___, Attorney Docket No. 129807-826647, filed on February ___, 2025, entitled “Techniques for Targeted Data Extraction from Unstructured Sets of Documents”; the contents of which are hereby expressly incorporated by reference in their entirety.

FIG. 3 illustrates an example of a computing system 700 that may be used to implement embodiments as described herein, including the server 106 and/or the client device 104. The computing system 700 may include additional components not shown and that some of the process components described may be removed and/or modified. In another example, a computing system 700 may be deployed on external-cloud platforms such as cloud, internal corporate cloud computing clusters, organizational computing resources, and/or the like.

The computing system 700 includes processor(s) 702, such as a central processing unit, ASIC or another type of processing circuit, input/output devices 704, such as a display, mouse keyboard, etc., a network interface 706, such as a Local Area Network (LAN), a wireless 802.11x LAN, a 3G or 4G mobile WAN or a WiMax WAN, and a computer-readable medium 708. Each of these components may be operatively coupled to a bus 710.

The computer-readable medium 708 may be any suitable medium that participates in providing instructions to the processor(s) 702 for execution. For example, the computer-readable medium 708 may be non-transitory or non-volatile medium, such as a magnetic disk or solid-state non-volatile memory or volatile medium such as RAM. The instructions or modules stored on the computer-readable medium 708 may include machine-readable instructions 712 executed by the processor(s) 702 that cause the processor(s) 702 to perform the methods and functions performed by the server 106 and/or the client device 104.

The computing system 700 may be implemented as software stored on a non-transitory processor-readable medium and executed by the processor(s) 702. For example, the computer-readable medium 708 may store an operating system 714, such as MAC OS, MS WINDOWS, UNIX, or LINUX, and code, for the computing system 700. The operating system 714 may be multi-user, multiprocessing, multitasking, multithreading, real-time, and the like. For example, during runtime, the operating system 714 is running and the code for the computing system 700 is executed by the processor(s) 702.

The computing system 700 may include a data storage 716, which may include non-volatile data storage. The data storage 716 stores any data used or generated by the computing system 700.

The network interface 706 connects the computing system 700 to internal systems for example, via a LAN. Also, the network interface 706 may connect the computing system 700 to the Internet. For example, the computing system 700 may connect to web browsers and other external applications and systems via the network interface 706.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine -readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer will also include or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. the processor(s) 702 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

A neural network architecture, which can be implemented by the processors 702 executing instructions 712 shown in FIG. 3, is used for determining a language associated with character recognition, as described above. This model can be trained to recognize characters associated with any language. Input data to such a neural network may be a page of a document, a portion of a page of a document, etc., and the output may be one or more recognized characters as described above.

The neural network can be defined by a neural network description stored on the storage medium 708 of FIG. 3. This description can include a full specification of the neural network, including its architecture. For example, the neural network description can include a description or specification of the architecture (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network includes an input layer, which includes input data. The input layer can include data representing a portion of the input media data such as a patch of data or pixels (e.g., a 128×128 patch of data) in an image corresponding to the input media data (e.g., images of the plurality of documents 222 selected in FIG. 2). The patch of data or pixels corresponds with data or pixels for character recognition as described herein. Additionally, or alternatively, the patch of data or pixels for character recognition may be one or more areas on one or more pages of one or more documents. The one or more documents may be selected based upon user input via the interface 200 shown in FIG. 2. Alternatively, the patch of data or pixels for character recognition may be automatically selected based upon quality of the patch of data or pixels for character recognition.

The neural network includes hidden layers. The hidden layers can include n number of hidden layers, where n is an integer greater than or equal to one. The number of hidden layers can include as many layers as needed for a desired processing outcome and/or rendering intent. The neural network further includes an output layer that provides an output resulting from the processing performed by the hidden layers. The output layer can provide labeling information of selected product(s).

The neural network is a multi-layer neural network of interconnected nodes. Each node can represent a piece of information. Information associated with the nodes is shared among the different layers and each layer retains information as information is processed. In some cases, the neural network can include a feed-forward neural network, in which case there are no feedback connections where outputs of the neural network are fed back into itself. In other cases, the neural network can include a recurrent neural network, which can have loops that allow information to be carried across nodes while reading in input.

Information can be exchanged between nodes through node-to-node interconnections between the various layers. Nodes of the input layer can activate a set of nodes in the first hidden layer. For example, each of the input nodes of the input layer is connected to each of the nodes of the first hidden layer. The nodes of the hidden layer can transform the information of each input node by applying activation functions to the information. The information derived from the transformation can then be passed to and can activate the nodes of the next hidden layer, which can perform their own designated functions. Example functions include convolutional, up-sampling, data transformation, pooling, and/or any other suitable functions. The output of the hidden layer can then activate nodes of the next hidden layer, and so on. The output of the last hidden layer can activate one or more nodes of the output layer, at which point an output is provided. A node in a neural network produces only one output value. When this output is used in several parts of the network, it is still the same single value being sent to multiple destinations.

In some cases, each node or interconnection between nodes can have a weight that is a set of parameters derived from training the neural network. For example, an interconnection between nodes can represent a piece of information learned about the interconnected nodes. The interconnection can have a numeric weight that can be tuned (e.g., based on a training dataset), allowing the neural network to be adaptive to inputs and able to learn as more data is processed.

The neural network can be pre-trained to process the features from the data in the input layer using the different hidden layers in order to provide the output through the output layer. In an example in which the neural network is used to identify a user and/or product(s), the neural network can be trained using training data that includes example images and/or labeling and characteristic information of the plurality of documents. For instance, training images can be input into the neural network, which can be processed by the neural network to generate outputs which can be used to tune one or more aspects of the neural network, such as weights, biases, etc.

In some cases, the neural network can adjust weights of nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For a first training iteration for the neural network, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, the neural network is unable to determine low level features and thus cannot make an accurate determination of what the classification of the object might be. A loss function can be used to analyze errors in the output. Any suitable loss function definition can be used.

The loss (or error) can be high for the first training dataset (e.g., images) since the actual values will be different than the predicted output. The goal of training is to minimize the amount of loss so that the predicted output comports with a target or ideal output. The neural network can perform a backward pass by determining which inputs (weights) most contributed to the loss of the neural network and can adjust the weights so that the loss decreases and is eventually minimized.

A derivative of the loss with respect to the weights can be computed to determine the weights that contributed most to the loss of the neural network. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network can represent any other neural or deep learning network, such as an autoencoder, a deep belief nets (DBNs), a recurrent neural networks (RNNs), etc.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps reordered, added, or removed. Accordingly, other implementations are within the scope of the following claims.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A computer-implemented method for improving character recognition, comprising:
receiving, via parallel processing by two or more processors, a plurality of documents stored in one or more databases;
generating, via the parallel processing by the two or more processors, a corresponding image for each page of the plurality of documents;
processing, via the parallel processing by the two or more processors, the corresponding image of each page of the plurality of documents to enhance character recognition in each corresponding image;
performing, via the parallel processing by the two or more processors, the character recognition in the corresponding image of each page of the plurality of documents to yield a plurality of recognized characters in the plurality of documents; and
reconstructing, via the parallel processing by the two or more processors, each page of the plurality of documents to include corresponding one or more characters from the plurality of recognized characters.

2. The computer-implemented method of claim 1, wherein processing the corresponding image comprises:
converting the corresponding image into a corresponding grayscale image;
applying Gaussian blurring to the corresponding grayscale image to reduce noise present in the corresponding grayscale image;
subsequent to applying the Gaussian blurring, enhancing text clarity in the corresponding grayscale image by sharpening the corresponding grayscale image; and
enhancing contrast for the character recognition in the corresponding grayscale image by dividing the corresponding grayscale image based on blurred areas of the corresponding grayscale image.

3. The computer-implemented method of claim 1, wherein the character recognition is performed using an optical character recognition (OCR) engine.

4. The computer-implemented method of claim 1, wherein reconstructing each page comprises:
converting, via the parallel processing by the two or more processors, the corresponding one or more characters into a machine-readable format; and
embedding, via the parallel processing by the two or more processors, the machine-readable format into a corresponding page of the plurality of documents.

5. The computer-implemented method of claim 4, further comprising:
storing, via the parallel processing by the two or more processors, the plurality of documents with the corresponding one or more characters at a user-specified directory path; and
generating, via the parallel processing by the two or more processors, a summary detailing one or more of:
a total number of documents that were processed,
a total number of successful conversions, and
a total number of errors.

6. The computer-implemented method of claim 1, wherein the character recognition is performed using a trained language model.

7. The computer-implemented method of claim 1, wherein,
the plurality of documents includes characters associated with at least two different languages, and
the character recognition for each of characters associated with the at least two different languages is performed using a respective trained language model.

8. A system for improving character recognition, the system comprising:
at least one memory configured to store computer-readable instructions; and
two or more processors communicatively coupled with the at least one memory, and configured to execute the computer-readable instructions to:
receive, via parallel processing, a plurality of documents stored in one or more databases;
generate, via the parallel processing, a corresponding image for each page of the plurality of documents;
process, via the parallel processing, the corresponding image of each page of the plurality of documents to enhance character recognition in each corresponding image;
perform, via the parallel processing, the character recognition in the corresponding image of each page of the plurality of documents to yield a plurality of recognized characters in the plurality of documents; and
reconstruct, via the parallel processing, each page of the plurality of documents to include corresponding one or more characters from the plurality of recognized characters.

9. The system of claim 8, wherein to process the corresponding image, the two or more processors are further configured to execute the computer-readable instructions to:
convert the corresponding image into a corresponding grayscale image;
apply Gaussian blurring to the corresponding grayscale image to reduce noise present in the corresponding grayscale image;
subsequent to applying the Gaussian blurring, enhance text clarity in the corresponding grayscale image by sharpening the corresponding grayscale image; and
enhance contrast for the character recognition in the corresponding grayscale image by dividing the corresponding grayscale image based on blurred areas of the corresponding grayscale image.

10. The system of claim 8, wherein the character recognition is performed using an optical character recognition (OCR) engine.

11. The system of claim 8, wherein to reconstruct each page, the two or more processors are further configured to execute the computer-readable instructions to:
convert, via the parallel processing, the corresponding one or more characters into a machine-readable format; and
embed, via the parallel processing, the machine-readable format into a corresponding page of the plurality of documents.

12. The system of claim 11, wherein the two or more processors are further configured to execute the computer-readable instructions to:
store, via the parallel processing, the plurality of documents with the corresponding one or more characters at a user-specified directory path; and
generate, via the parallel processing, a summary detailing one or more of:
a total number of documents that were processed,
a total number of successful conversions, and
a total number of errors.

13. The system of claim 8, wherein the character recognition is performed using a trained language model.

14. The system of claim 8, wherein,
the plurality of documents includes characters associated with at least two different languages, and
the character recognition for each of characters associated with the at least two different languages is performed using a respective trained language model.

15. One or more non-transitory computer-readable media comprising computer-readable instructions, which when executed by two or more processors of a system for improving character recognition, cause the system to:
receive, via parallel processing, a plurality of documents stored in one or more databases;
generate, via the parallel processing, a corresponding image for each page of the plurality of documents;
process, via the parallel processing, the corresponding image of each page of the plurality of documents to enhance character recognition in each corresponding image;
perform, via the parallel processing, the character recognition in the corresponding image of each page of the plurality of documents to yield a plurality of recognized characters in the plurality of documents; and
reconstruct, via the parallel processing, each page of the plurality of documents to include corresponding one or more characters from the plurality of recognized characters.

16. The one or more non-transitory computer-readable media of claim 15, wherein to process the corresponding image, the two or more processors are further configured to execute the computer-readable instructions to cause the system to:
convert the corresponding image into a corresponding grayscale image;
apply Gaussian blurring to the corresponding grayscale image to reduce noise present in the corresponding grayscale image;
subsequent to applying the Gaussian blurring, enhance text clarity in the corresponding grayscale image by sharpening the corresponding grayscale image; and
enhance contrast for the character recognition in the corresponding grayscale image by dividing the corresponding grayscale image based on blurred areas of the corresponding grayscale image.

17. The one or more non-transitory computer-readable media of claim 15, wherein the character recognition is performed using an optical character recognition (OCR) engine or a trained language model.

18. The one or more non-transitory computer-readable media of claim 15, wherein to reconstruct each page, the two or more processors are further configured to execute the computer-readable instructions to cause the system to:
convert, via the parallel processing, the corresponding one or more characters into a machine-readable format; and
embed, via the parallel processing, the machine-readable format into a corresponding page of the plurality of documents.

19. The one or more non-transitory computer-readable media of claim 18, wherein the two or more processors are further configured to execute the computer-readable instructions to cause the system to:
store, via the parallel processing, the plurality of documents with the corresponding one or more characters at a user-specified directory path; and
generate, via the parallel processing, a summary detailing one or more of:
a total number of documents that were processed,
a total number of successful conversions, and
a total number of errors.

20. The one or more non-transitory computer-readable media of claim 15, wherein,
the plurality of documents includes characters associated with at least two different languages, and
the character recognition for each of characters associated with the at least two different languages is performed using a respective trained language model.
